(19) United States
(12) Patent Application Publication
(10) Pub. No.: US 2023/0405640 A1
(43) Pub. Date: Dec. 21, 2023

(54) A SYSTEM AND METHOD FOR THE DETECTION AND REMOVAL OF DEFECTIVE DRIPPERS

(71) Applicant: METZERPLAS COOPERATIVE AGRICULTURAL ORGANIZATION LTD., M.P. Heffer (IL)

(72) Inventors: Yitzhak ROTEM, M.P. Heffer (IL); Avi MOTOVA, Haifa (IL)

(21) Appl. No.: 18/248,038

(22) PCT Filed: Aug. 9, 2021
(86) PCT No.: PCT/IL2021/050970

§ 371 Date: Apr. 5, 2023

(30) Foreign Application Priority Data
Oct. 20, 2020 (IL) 278191

(51) Int. Cl. B07C 5/36; G01N 21/88; B07C 5/34

(52) U.S. Cl. CPC B07C 5/362; G01N 2021/845; B07C 5/34; G01N 21/8806

(57) ABSTRACT

A system for detecting defects in articles moving along a production line and for removing detected defective articles comprises 1) a detection unit comprising: a) at least one light source, b) at least one image-capturing device, and c) a graphic processing unit; 2) a removal unit, located downstream from said detection unit, comprising a plurality of article-grabbing elements, suitable to latch onto said articles; and 3) processing apparatus suitable to determine the position of an article to be removed on the moving processing line, and the expected time when said article to be removed will be positioned in a removably suitable location relative to an article-grabbing element, and to transmit data relative thereto to an actuating circuitry of said removal unit.

### FIELD OF THE INVENTION

The present invention relates to a system and a method for detecting defective drippers in a production line and for the removal thereof.

### BACKGROUND OF THE INVENTION

In-line drippers are extensively used in agriculture as part of dripping lines. Manufacturing such dripping lines requires a large number of small drippers, which are positioned inside the dripping line during manufacturing. An illustration of a segment of such a dripping line is shown in FIG. 1, in which a dripper 100 is shown in a segment of tube 101, a section of which has been removed. The dripper itself is further shown in greater detail in FIG. 2. The problem addressed by the invention concerns the handling of small articles, e.g., weighing 0.1 gram each, which are fed at a high rate, such as, for example, 3,000 units per minute, to equipment that integrates them into the final product. The invention aims at maintaining a high quality of the final product by avoiding misplacement of the small articles therein. While the invention is illustrated using drippers and dripping lines, it will be understood that it is applicable to a variety of small articles to be incorporated in a production line, and the invention is intended to cover any such production line.

The drippers used in this technology are very small, ranging in length between about 11 mm to about 21 mm, and are deployed along the line at distances between them ranging from 0.2 m to 1 m. Accordingly, in mass production, thousands of drippers are produced on each production line per minute. The drippers are manufactured by injection molding and, as will be apparent to the skilled person, this technology has as an inherent drawback that a percentage of the drippers so manufactured will be defective, either because of extra plastic material remaining on the dripper, which may create a defect in the course of attaching the dripper to the inner surface of the tube or because an incomplete filling of the material in the mold, which may result in a malfunctioning of the dripper.

Dripping lines are typically manufactured by taking the drippers leaving the mold, and feeding them to the tubing creating stage. Even if the production of the dripping line were made into separate stages, the problem would still remain to locate and remove defective drippers. This procedure cannot efficiently be done manually, and because of the small size of the dripper, it presents considerable challenges.

It is therefore clear that it would be highly desirable to be able to remove defective drippers from the manufacturing line before they are fed to the dripping line manufacturing stage.

While drippers are an important example of the application of the present invention, the methods, and systems described herein can be applied to other manufacturing lines, in which defects may occur. These include, for instance, any injected plastic article of manufacture that has to be assembled or incorporated in a larger body, such as, for instance, electric contactors, medical parts of infusion systems containing spigots or T-junctions, fixed or moving parts of measuring equipment, watches, etc.

It is therefore an object of the invention to provide a method and systems for detecting defects in articles of manufacture and for removing defective articles from the production line. It is a further object of the invention to apply said methods and systems to manufacturing lines that produce large numbers of small items.

Accordingly, it is an object of the present invention to provide a method and system for detecting defects in drippers.

It is another object of the invention to provide a simple and cost-effective system for inspecting drippers in a fully automated manner and without the need for human intervention.

It is yet another object of the invention to provide a method and apparatus for removing drippers that have been determined to be defective or potentially defective, said removal being carried out dynamically along the manufacturing line.

All the above and other characteristics and advantages of the invention will become apparent as the description proceeds.

### SUMMARY OF THE INVENTION

In one aspect, the invention is directed to a system for detecting defects in articles moving along a production line and for removing detected defective articles, comprising:
1. a detection unit comprising:
   a) at least one light source;
   b) at least one image-capturing device;
   c) a graphic processing unit;
ii. b removal unit, located downstream from said detection unit, comprising:
   d) a plurality of article-grabbing elements, suitable to latch onto said articles; and
iii. processing apparatus suitable to determine the position of an article to be removed on the moving processing line, and the expected time when the said article to be removed will be positioned in a removably suitable location relative to an article-grabbing element, and to transmit data relative thereto to an actuating circuitry of said removal unit.

According to an embodiment of the invention, the beam of the said light source and the field of view of said image-capturing device overlap in the inspection area and are aimed toward said products from different directions. In another embodiment, the image-capturing device communicates with the said graphic processing unit, which is suitable to analyze the surface of the article appearing in the captured images by the light-and-shadow effects created by the said light source. In a further embodiment, the light source grazes the inspected products. In yet another embodiment, the light source is located essentially laterally in relation to the inspected objects.

The system of the invention can operate with different numbers of light sources, and according to one embodiment, two light sources are located around the inspected products.

The light sources may operate continuously, or they may operate alternately. As will be apparent to the skilled person, different lighting and image-capturing setups can be devised, depending on the specific setup of the manufacturing line, and in one embodiment, there is more than one pair of a light source and image-capturing devices.

The graphic processing unit and the image-capturing device may be connected in various ways, for instance, physically. In another embodiment, the graphic processing unit and the image-capturing device are remotely connected.

The article-grabbing elements may be of different types, depending on the size of the products to be removed, their number per specific area, their weight, the shape of their surface, etc. The skilled person will easily devise the most effective set. According to one embodiment, the article-grabbing elements comprise pneumatic apparatus. In another embodiment, the article-grabbing elements comprise mechanical apparatus.

Because of the need to remove articles located different X-Y locations along the moving line, such as a belt, the removal unit comprises a plurality of article grabbing elements, which may be of any type known to the skilled person, for instance, air nozzles equipped with open-close valves, mechanical grippers, or any other suitable gripping element selected according to the article in question by the skilled person.

The system of the invention can be devised to remove articles having different shapes and other characteristics. According to one embodiment, the article is a dripper. It should be understood that while a large portion of defective articles will be removed when operating according to the invention, it is not possible—and it is not the purpose of the invention—to remove 100% of all defective articles. This is so because the inspection system may not locate all the defective articles because of overlap between articles on the moving line, because the defect may be located on the lower surface, which is hidden from view, because the article-grabbing element failed to latch onto a defective article, etc. However, operating according to the invention will successfully remove the vast majority of defective articles, thus improving the quality of the final product. Moreover, alerts given by the system to the operator when defective articles are located and removed are important inputs that facilitate the identification of the origin of the problem that created the defective article in the first place.

As said, while the invention is particularly useful in the field of dripper manufacturing, it is also useful in many other cases, such as when the article is selected from any injected plastic article of manufacture that has to be assembled or incorporated into a larger body, such as, for instance, electric contactors, medical parts of infusion systems containing spigots or T-junctions, fixed or moving parts of measuring equipment, watches, etc.

The invention is also directed to a method for detecting defects in articles moving along the production line and for removing detected defective articles, comprising:
1. providing a detection unit comprising:
   a) at least one light source;
   b) at least one image-capturing device;
   c) a graphic processing unit;
2. providing a removal unit, located downstream from said detection unit, comprising:
   d) a plurality of article-grabbing elements, suitable to latch onto said articles; and
3. determining, by processing apparatus, the position of an article to be removed on the moving processing line, determining the expected time when said article to be removed will be positioned in a removably suitable location relative to an article-grabbing element, and transmitting data relative thereto to an actuating circuitry of said removal unit, whereby to cause said article grabbing element to latch onto the said article to be removed, thereby removing it from the production line.

In one embodiment of the invention, the analysis of the image is performed using neural networks. In another embodiment of the invention, the analysis employs a deep learning algorithm.

All the above characteristics and advantages of the invention will be further understood from the following description of illustrative embodiments thereof, with reference to the appended drawings.

### BRIEF DESCRIPTION OF THE DRAWINGS

In the drawings:

FIG. 1 illustrates the location of a dripper inside a dripping line;

FIG. 2 shows a single exemplary dripper;

FIG. 3 (a and b) shows an inspection device according to one embodiment of the invention;

FIG. 4 shows the inspection device of FIG. 3 in side view; and

FIG. 5 shows a removal device positioned downstream of the conveyor belt.

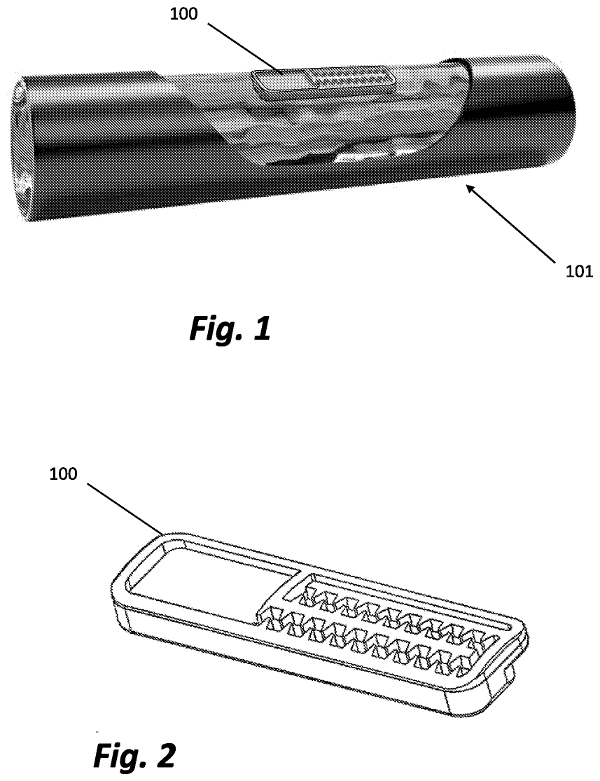

### DETAILED DESCRIPTION OF THE INVENTION

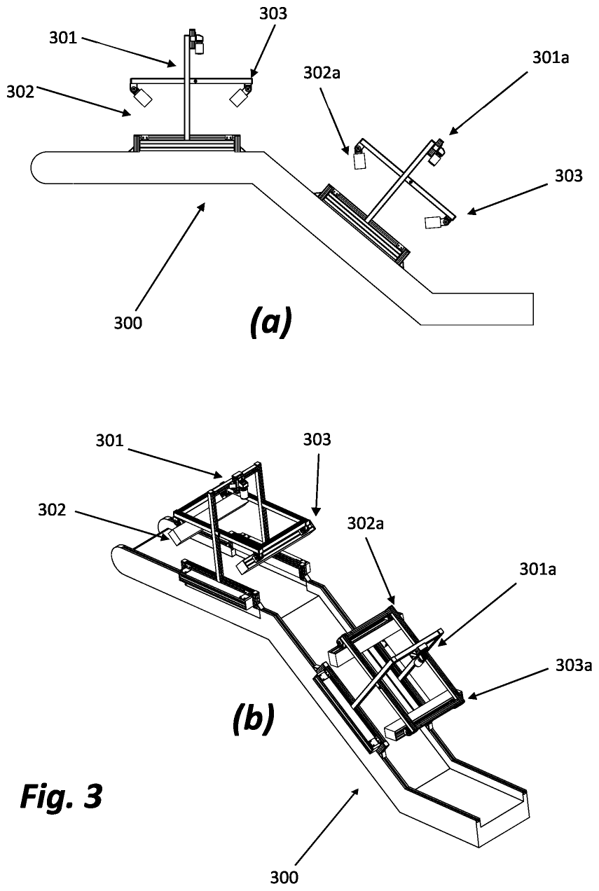

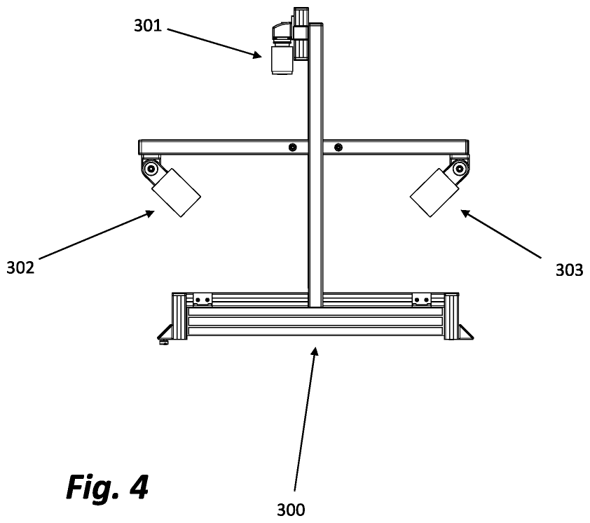

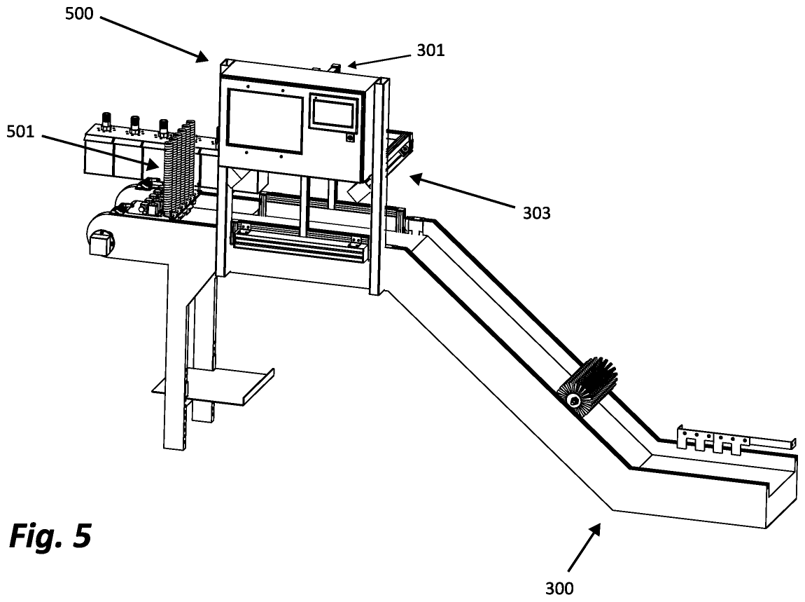

FIG. 3 (a and b) is a schematic view (a) and perspective view (b) of the system according to one embodiment of the invention, which comprises a conveyor 300, a camera 301, and two light sources 302 and 303, whose light grazes the drippers moving along the conveyor belt. The camera and lights can be positioned at different locations, and FIG. 3 shows them located at the top of the conveyor belt. An alternative location is also shown in the figure, where camera 301a and lights 302a and 303a. Camera 301 can be replaced with any other image-capturing equipment. The system inspects the drippers as they pass under the camera, and the images of the drippers are fed to a computer system, the operation of which will be further described hereinafter, which identifies potentially defective drippers, notes there X-Y location on the conveyor belt, and transmits them to the removal system located downstream, which will be described later on. After an image is captured, it is sent to a graphic processing unit (which may be a commercial GPU or other hardware or software) for defect analysis. In order to increase the performance of the system, the camera can be a high-resolution camera that captures a high number of frames per second.

The graphic processing unit used in the invention can analyze the outlines of a product and determine if they depart from the expected shape, e.g., if there is additional plastic material or missing plastic material, compared with a non-defective dripper. The use of a light source is required for analyzing the surface of the dripper. If the GPU detects shadows on the surface, it can indicate the presence of protrusions or pits in the dripper.

The images acquired by the system of the invention can be analyzed by a variety of methods. For instance, darker areas can be used to determine surface quality by simple image analysis, using image processing methods known in the art, which are not discussed herein, for the sake of brevity. If more sophisticated determinations are desired, neural network and deep learning methods can be employed, such as the illustrative classification algorithm described hereinafter.

Illustrative Classification Algorithm

An exemplary classification algorithm is based on a deep convolutional neural network (CNN) which is trained using images of good products and different examples of defective products. The training examples include recordings of machine runs with good products, machine runs with defective products, and several types of simulations. “Deep Learning” (also called deep structured learning, hierarchical learning, or deep machine learning) is a family of machine learning algorithms characterized by multiple processing layers. Since 2012, these methods have gained very high popularity in the field of computer vision and other fields as well. Currently, the state of the art in many computer vision tasks is achieved with algorithms based on these methods.

The advantages of Deep Learning methods are:
1. They can generate very complex functions.
2. The classifiers can learn from examples without the need for manually engineered features.
3. They can be run and trained very efficiently on parallel computing platforms such as GPUs (graphical processing units).

The system can be trained to identify the various types of coating defects and other defects such as broken pills. An illustrative description of a training procedure is provided below.

Training Procedure

The training procedure, according to an embodiment of the invention, comprises the following steps:
1. Record good products.
2. Record defected products
3. Activate Foreground-Background segmentation to detect the pixels that contain products. The segmentation generates blobs that contain the product's pixels.

All the blobs will be used for training unless overlapping of products or products was partially captured or was out of focus.
4. Train a deep convolutional neural network to classify each frame (or each series of consequent frames) in the training set as either Good or Bad.
5. In an exemplary embodiment, the network architecture used is that described in, Szegedy, Christian, Wei Liu, Yangqing Jia, Pierre Sermanet, Scott Reed, Dragomir Anguelov, Dumitru Erhan, Vincent Vanhoucke, and Andrew Rabinovich. “Going deeper with convolutions.” In Proceedings of the IEEE Conference on Computer Vision and Pattern Recognition, pp. 1-9. 2015, although other architectures may be used. The network coefficients (excluding the coefficients of the classification layers) were initialized with a network that was trained on ImageNet classification challenge (as described in Olga Russakovsky, Jia Deng, Hao Su, Jonathan Krause, Sanjeev Satheesh, Sean Ma, Zhiheng Huang, Andrej Karpathy, Aditya Khosla, Michael Bernstein, Alexander C. Berg and Li Fei-Fei. ImageNet Large Scale Visual Recognition Challenge. UCV, 2015). The classification layers coefficients were initialized with a random Gaussian distribution. The back-propagation algorithm was used to train the network, as described in “Pattern Classification” by Duda, Hart, Stork, Wiley & Sons Inc., 2001, pp. 288.

All the above description of preferred embodiments has been provided for the purpose of illustration and are not intended to limit the invention in anyway. Many modifications can be provided. For instance, different numbers of cameras and/or light sources can be used, concurrently or alternating, different lighting angles can be used for the grazing light; inspection apparatus may be located at different positions along the path followed by the drippers; different removal apparatus may be employed all without exceeding the scope of the invention as defined in the appended claims.

1. A system for detecting defects in articles moving along a production line and for removing detected defective articles, comprising:
i. a detection unit comprising:
a) at least one light source;
b) at least one image-capturing device;
c) a graphic processing unit;
ii. a removal unit, located downstream from said detection unit, comprising:
d) a plurality of article-grabbing elements, suitable to latch onto said articles; and
iii. processing apparatus suitable to determine the position of an article to be removed on the moving processing line, and the expected time when said article to be removed will be positioned in a removably suitable location relative to an article-grabbing element, and to transmit data relative thereto to an actuating circuitry of said removal unit.

2. A system according to claim 1, wherein the beam of said light source and the field of view of said image-capturing device overlap in the inspection area and are aimed toward said products from different directions.

3. A system according to claim 1 wherein said image-capturing device communicates with said graphic processing unit, which is suitable to analyze the surface of the article appearing in the captured images by the light-and-shadow effects created by said light source.

4. A system according to claim 1, wherein the light source grazes the inspected products.

5. A system according to claim 1, wherein the light source is located essentially laterally in relation to the inspected objects.

6. A system according to claim 1, wherein two light sources are located around the inspected products.

7. A system according to claim 5, wherein the light sources operate alternately.

8. A system according to claim 1, wherein there is more than one pair of light source and image-capturing devices.

9. A system according to claim 1, wherein the graphic processing unit is connected to the image-capturing device.

10. A system according to claim 9, wherein the graphic processing unit and the image-capturing device are remotely connected.

11. A system according to claim 1, wherein the article-grabbing elements comprise pneumatic apparatus.

12. A system according to claim 1, wherein the article-grabbing elements comprise mechanical apparatus.

13. A system according to claim 1, wherein the article is a dripper.

14. A system according to claim 1, wherein the article is selected from injected plastic articles of manufacture that have to be assembled or incorporated in a larger body, including electric contactors, medical parts of infusion systems containing spigots or T-junctions, fixed or moving parts of measuring equipment, watches, and the like.

15. A method for detecting defects in articles moving along a production line and for removing detected defective articles, comprising:
i. Providing a detection unit comprising:
a) at least one light source;
b) at least one image-capturing device;
c) a graphic processing unit;
ii. Providing a removal unit, located downstream from said detection unit, comprising:
d) a plurality of article-grabbing elements, suitable to latch onto said articles; and
iii. Determining, by processing apparatus, the position of an article to be removed on the moving processing line, determining the expected time when said article to be removed will be positioned in a removably suitable location relative to an article-grabbing element, and transmitting data relative thereto to an actuating circuitry of said removal unit, whereby to cause said article grabbing element to latch onto the said article to be removed, thereby removing it from the production line.

16. A method according to claim 15, wherein the analysis of the image is performed using neural networks.

17. A method according to claim 16, wherein the analysis employs a deep learning algorithm.

18. A method according to claim 15, wherein the articles are drippers.
